(19) United States
(12) Patent Application Publication
(10) Pub. No.: US 2019/0133079 A1
(43) Pub. Date: May 9, 2019

(54) PLAYING DEVICE FOR PET

(71) Applicant: J CONTENTS CO., Ltd., Sejong-si (KR)

(72) Inventor: Kwang Hun JANG, Cheonan-si (KR)

(21) Appl. No.: 15/822,049

(22) Filed: Nov. 24, 2017

(30) Foreign Application Priority Data
Nov. 3, 2017 (KR) 10-2017-0146265

(51) Int. Cl. A01K 15/02

(52) U.S. Cl. CPC A01K 15/025; A63B 43/06

(57) ABSTRACT

Provided is a playing device which includes a spherical playing device body having a hollow interior, having a plurality of emission holes and one coupling hole on a surface thereof, and configured to be rolled and rotated by a pet, a core coupled to the interior of the playing device body through the coupling hole and having a plurality of vent holes on a surface thereof, a melody generating unit installed in the interior of the core and configured to generate a melody when the playing device is rolled and rotated, a light generating unit installed in the interior of the core and configured to generate light when the playing device is rolled and rotated, and a control unit installed in the interior of the core and configured to detect an impact generated when the playing device is rotated to operate the melody generating unit and the light generating unit.

### CROSS-REFERENCE TO RELATED APPLICATION

This application claims priority from and the benefit under 35 U.S.C. § 119(a) of Korean Patent Application No. 10-2017-0146265, filed on Nov. 3, 2017, which is hereby incorporated by reference for all purposes as if fully set forth herein.

### BACKGROUND OF THE INVENTION

### 1. Field of the Invention

The present invention relates to a playing device for a pet, and more particularly, to a playing device for a pet, which a pet such as a dog or a cat may play with.

### 2. Description of the Prior Art

In the modern society, the number of one-child families and families of senior citizens who live alone are increasing due to a decrease of the number of family members according to the nuclear families. Further, due to a higher divorce rate and higher marriage ages, the number of young people who live alone is increasing.

Accordingly, the number of people who live together with pets is increasing to increase the quality of life, for example, to comfort loneliness and obtain emotional stability.

In particular, because among the pets, dogs or cats have high intelligence, excellent adaptability, and an ability to coexist while sharing feelings with the owners as compared with the other animals, they are recognized as members of the family instead of simple animals that are raised for hubby or fun and the culture in which people feel ties or senses of kinship as companion animals is becoming general.

However, because the persons who raise pets have to do various outdoor activities for office works, promises, and hobby lives, they cannot be always together with the pets and the pets often live alone according to the outdoor activities of the owners.

However, when the pets live alone for a long time, they may suffer various physical and psychological diseases, such as depressive disorders due to severe stresses, emotional instabilities, lack of exercises, obesities, and diabetes, and the physical and psychological diseases may cause the social problem of generating abandoned dogs.

Accordingly, playing devices by which the pets may solve exercises and stresses while feeling fun when they live alone are required.

In recent years, in order to compensate for this, various playing devices which the pets may play with alone have been suggested.

However, because pets lose interests after use of the conventional playing devices or pets for a specific time due to their simple structures and functions, they cannot be continuously interested.

Further, the conventional playing devices for pets employ only limited functions of deriving interests of pets, and accordingly, cannot secure various functions, lower practicality, and cannot contribute to the luxuriousness of the products.

### PRIOR TECHNICAL DOCUMENTS

### Patent Documents

(Patent Document 0001) Korean Patent No. 10-1773672 (Aug. 25, 2017)

(Patent Document 0002) Korean Patent Application Publication No. 10-2015-0018062 (Feb. 23, 2015)

(Patent Document 0003) Korean Utility Model No. 20-0483610 (May 29, 2017)

(Patent Document 0004) Korean Patent Application Publication No. 10-2015-0053455 (May 18, 2015)

(Patent Document 0005) Korean Patent Application Publication No. 10-2014-0092530 (Jul. 24, 2014)

### SUMMARY OF THE INVENTION

The present invention provides a playing device for a pet that may generate a melody and light while the playing device is rolled and rotated by a pet.

The present invention also provides a playing device for a pet that may prevent a safety accident by absorbing an collision impact with a pet.

The present invention also provides a playing device for a pet that may remove foreign substances, such as hairs separated from a pet or dusts which drop onto the bottom, by allowing the foreign substances to be stuck to the playing device.

The present invention also provides a playing device for a pet that may protect a pet from harmful electronic waves emitted from various electronic devices.

The present invention also provides a playing device for a pet that may be sanitarily managed by securing a structure that may be washed.

The technical objects of the present invention are not limited to the above-mentioned ones, and the other technical objects will be clearly understood by an ordinary person skilled in the art to which the present invention pertains.

In accordance with an aspect of the present invention, there is provided a playing device for a pet, including a spherical playing device body having a hollow interior, having a plurality of emission holes and one coupling hole on a surface thereof, and configured to be rolled and rotated by a pet, a core coupled to the interior of the playing device body through the coupling hole and having a plurality of vent holes on a surface thereof, a melody generating unit installed in the interior of the core and configured to generate a melody when the playing device is rolled and rotated, a light generating unit installed in the interior of the core and configured to generate light when the playing device is rolled and rotated, and a control unit installed in the interior of the core and configured to detect an impact generated when the playing device is rotated to operate the melody generating unit and the light generating unit.

The playing device body may include a spherical member having a pair of hemispherical bodies which are coupled to each other to form a spherical shape, and a sheathing member coupled to the spherical member to completely surround a surface of the spherical member.

The playing device body may have a plurality of bosses on a surface thereof to be rolled and rotated only by an external force delivered from the pet, and the bosses have embossed shapes.

The playing device body may further include a sticking/coating layer formed on a surface of the sheathing member such that hairs or foreign substances of the pet are stuck to the sticking/coating layer.

The sheathing member may be formed by mixing soft silicon and tourmaline powder.

The core may include a core body having a hollow cylindrical shape of a specific length and having an opening on a surface thereof such that the melody generating unit, the light generating unit, and the control unit are installed in the core body, and a cover formed to open and close the opening.

The core body may further include a main body in which the melody generating unit, the light generating unit, and the control unit are installed, and an auxiliary body coupled to the main body and in which feeds of the pet are accommodated.

The core may be formed of a transparent body such that the light generated by the light generating unit is emitted to the outside of the playing device body.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view three-dimensionally illustrating a playing device for a pet according to a first embodiment of the present invention;

FIG. 2 is a sectional view illustrating the interior of the playing device for a pet according to the present invention;

FIG. 3 is a block diagram illustrating a configuration for explaining an operational principle of the playing device for a pet according to the present invention;

FIG. 4 is a sectional view illustrating a process of coupling a playing device body provided in the playing device for a pet according to the present invention;

FIG. 5 is a perspective view three-dimensionally illustrating a core provided in the playing device for a pet according to the present invention; and

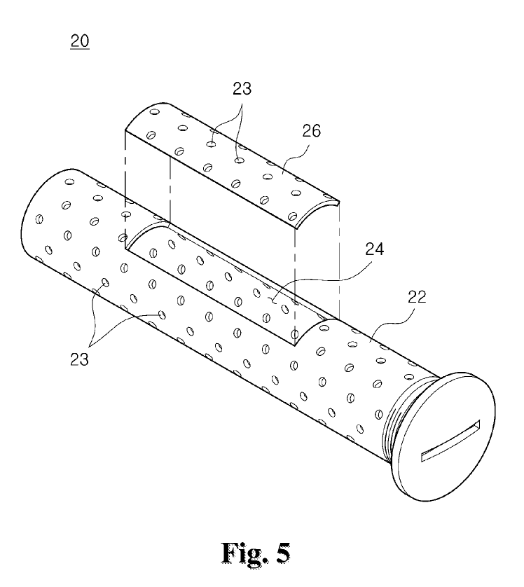

FIG. 6 is a sectional view illustrating the interior of the playing device for a pet according to a second embodiment of the present invention.

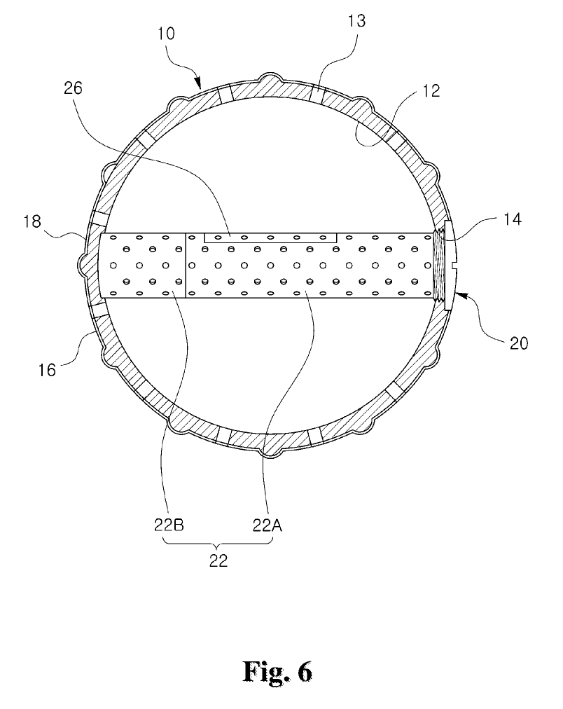

### DETAILED DESCRIPTION OF THE EXEMPLARY EMBODIMENTS

Hereinafter, preferred embodiment of the present invention will be described in detail with reference to the accompanying drawings. Meanwhile, in a description of the present invention, known functions or configurations will not be described to make the essence of the present invention clear.

### First Embodiment

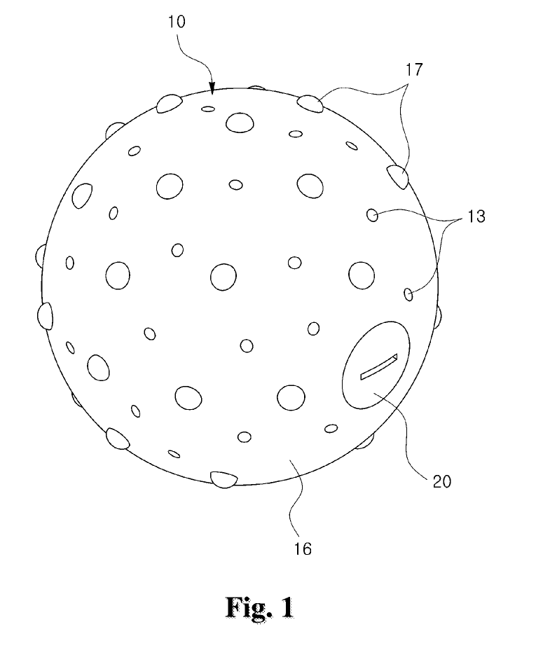

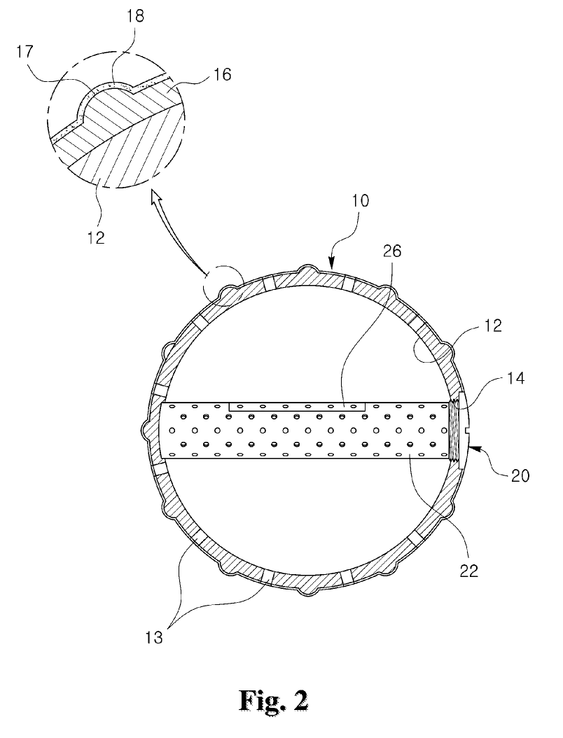

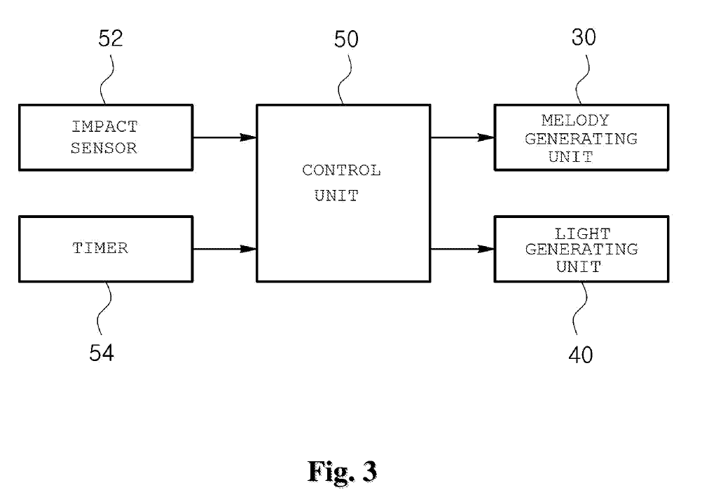

As illustrated in FIGS. 1 to 3, a playing device for a pet according to a first embodiment of the present invention includes a playing device body 10, a core 20, a melody generating unit 30, a light generating unit 40, and a control unit 50.

The playing device body 10 has a spherical shape, the interior of which is hollow. That is, because the entire outer appearance of the playing device body 10 is spherical, the playing device for a pet may be rolled by an external force transmitted from a pet.

Further, the playing device body 10 forms a main frame of the playing device for a pet and includes a spherical member 12, a sheathing member 16, and a sticking/coating layer 18.

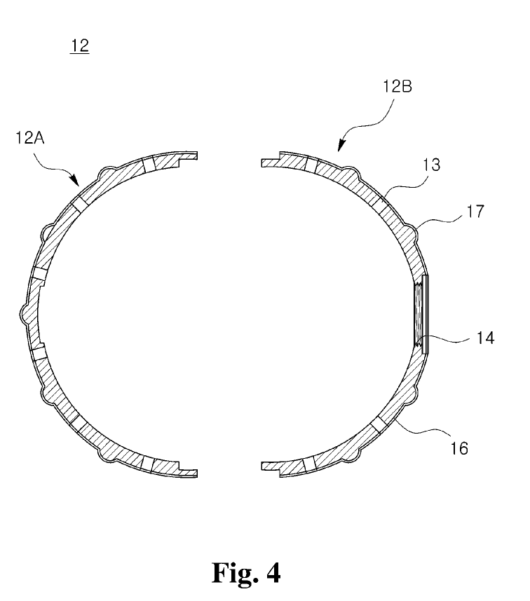

As illustrated in FIG. 4, the spherical member 12 has a pair of hemispherical bodies 12A and 12B, which are coupled to each other to form a spherical shape. That is, the spherical member 12 is constituted as the pair of hemispherical bodies 12A and 12B are formed of a hard synthetic resin, and are screw-coupled to each other to form a spherical shape.

The sheathing member 16 is coupled to a surface of the spherical member 12. That is, the sheathing member 16 is formed of soft silicon that is not harmful to a human body or a pet to completely surround the surface of the spherical member 12. The sheathing member 16 may be coupled to the hemispherical bodies 12A and 12B constituting the spherical member 12, respectively, or may be coupled to the spherical member 12 that is finished to have a spherical shape with the hemispherical bodies 12A and 12B.

Here, although not illustrated, when the sheathing member 16 is coupled to the spherical member 12 finished to have a spherical shape, the sheathing member 16 has a shape corresponding to the spherical member 12 and may have a cutaway part for entrance and exit of the spherical member 12. That is, the spherical member 12 is coupled to the interior of the sheathing member 16 through the cutaway part and is integrally formed with the sheathing member 16.

Because the above-mentioned sheathing member 16 secures a specific impact absorbing force due to silicon, a safety accident of a pet may be prevented by absorbing an impact generated in a playing process.

Further, the sheathing member 16 may be formed by mixing silicon and a predetermined amount of tourmaline powder. Accordingly, a pet may be protected by interrupting harmful electronic waves emitted from various electronic devices.

That is, tourmaline is an ore that pertains to a hexagonal system having a crystalline structure such as crystal, and it is known that, in addition to an electronic wave interrupting function, tourmaline expedites metabolism of the human body by generating far infrared rays and negative ions, activates cell functions and immunity functions, and helps circulation and purification of blood due to a strong heating effect and a high penetration force.

Accordingly, the sheathing member 16 ma secure a health promotion structure while protecting a pet from electronic waves.

Further, the sheathing member 16 has a plurality of bosses 17. The bosses 17 are regularly or irregularly disposed on the surface of the sheathing member 16, and have embossed shapes. Accordingly, the playing device body 10 is rolled and rotated only by an external force delivered from a pet, and may is not moved due to the bosses 17 when an external force is not delivered.

Further, the sticking/coating layer 18, such as a stick member, is formed on the entire surface of the sheathing member 16. Accordingly, various foreign substances, such as hairs or dusts that are separated from a pet and drop onto the bottom may be easily stuck or removed by the sticking/coating layer 18 while the playing device body 10 is rolled and rotated.

Here, when the sticking force of the sticking/coating layer 18 is too strong, the pet may avoid the playing device for a pet in a playing process.

Unlike this, when the sticking force of the sticking/coating layer 18 is weak, various foreign substances, such as hairs or dusts, which drop onto the bottom cannot be readily stuck.

Accordingly, it is considered that the sticking force of the sticking/coating layer 18 has a sticking force of a middle level that is strong enough to stick various foreign substances, such as hairs or dusts.

The core 20 is coupled to the interior of the playing device body 10, and includes a core body 22 and a cover 26.

The core 20 has a plurality of vent holes on a surface thereof, and is coupled to the interior of the playing device body 10 through a coupling hole 14. That is, the core 20 is normally coupled to the interior of the playing device 10, and is separated from the playing device body 10 according to necessities. To achieve this, the core 20 is screw-coupled to the playing device body 10.

Further, the core is formed of a transparent body such that light generated by the light generating unit 40 may be emitted to the outside of the playing device body 10.

The core body 22 has a hollow cylindrical shape having a specific length. The melody generating unit 30, the light generating unit 40, and the control unit 50 are installed in the interior of the core body 22. To achieve this, the core body 22 has an opening 24 on a surface thereof

The cover 26 opens and closes the opening 24 of the core body 22. Accordingly, the melody generating unit 30, the light generating unit 40, and the control unit 50 may be easily installed in the core body 22 and introduction of foreign substances may be prevented.

The melody generating unit 30 is installed in the interior of the core 20. The melody generating unit 30 is operated according to a control signal of the control unit 50 to generate a set melody.

Here, music liked by the pet or a voice message of the owner is stored in the melody generating unit 30 in advance.

Accordingly, the pet may feel comfortable in the playing process through the music or voice message generated by the melody generating unit 30.

In addition, the melody generating unit 30 may store new music or a new voice message of the owner.

The light generating unit 40 is installed in the interior of the core 20. The light generating unit 40 is operated according to a control signal of the control unit 50 to generate preset light.

Here, the light generating unit 40 may have various lamps that may generate light of colors liked by the pet.

The pet may be interested in the playing process by the light generating unit 40, and accordingly, may be prevented from being bored even after a long-time use of the playing device for a pet.

The control unit 50 is installed in the interior of the core 20. The control unit 50 functions to operate the melody generating unit 30 and the light generating unit 40. That is, the control unit 50 detects an impact generated while the playing device body 10 is rotated to operate the melody generating unit 30 and the light generating unit 40.

To achieve this, the control unit 50 includes an impact sensor 52 for detecting an impact delivered from the pet to the playing device body 10. That is, the control unit 50 detects an impact delivered to the playing device body 10 with the impact sensor 52 and operates the melody generating unit 30 and the light generating unit 40 through detection information of the impact sensor 52.

Further, the control unit 50 may further include a timer 54 that may operate the melody generating unit 30 and the light generating unit 40 for a preset time when an impact of the pet is delivered to the playing device body 10. Accordingly, the consumption of the power supplied to the control unit 50 may be reduced.

Here, although not illustrated, a battery that supplies electric power to the control unit 50 for operations of the melody generating unit 30 and the light generating unit 40 is installed in the interior of the core 20 to be exchangeable.

Hereinafter, an operation of the playing device for a pet according to the embodiment of the present invention will be described.

First, the play device body 10 is rolled and rotated by an external force delivered from a pet, and the control unit 50 operates the melody generating unit 30 and the light generating unit 40 after detecting an impact generated while the playing device body 10 is rotated with the impact sensor 52. Then, a set melody generated by the melody generating unit 30, for example, music enjoyed by the pet or a voice message of the owner is emitted to the outside of the body 10 through the vent holes 23 and emission holes 13 of the core 20, and the light generated by the light generating unit 40 passes through the core 20 and is mitted to the outside of the playing device body 10 through the emission holes 13.

Accordingly, because the present invention may derive curiosities of the pet through the melody and the light emitted to the outside of the playing device body 10 such that the pet may be continuously interested, the pet may be prevented from being bored even after a long-time use of the playing device for a pet.

Because the playing device body 10 may absorb an impact arbitrarily generated by the sheathing member 16 while the playing device body 10 is rolled and rotated, it may prevent a safety accident of the pet that may be generated in the playing process.

Because the sheathing member 16 may interrupt electronic waves generated by various electronic devices while the pet plays with the playing device for a pet, it may protect the pet from electronic waves. This may be achieved because the sheathing member 16 is formed by mixing soft silicon and tourmaline powder.

Because the sticking/coating layer 18 is formed of a sticky material such as a sticky member on a surface of the sheathing member 16, foreign substances such as hairs or dusts dropping onto the bottom may be stuck and removed when the pet plays with the playing device for a pet, and thus a cleaning environment may be secured in the playing process.

Meanwhile, the playing device body 10 is prevented from being arbitrarily rotated due to the bosses 17 formed in the sheathing member 16 when the external force delivered from the pet disappears. Then, as the detection information is not delivered from the impact sensor 52, the control unit 50 stops operations of the melody generating unit 30 and the light generating unit 40.

Further, because the core 20 is separated from the playing device body 10, the playing device body 10 is separated into the pair of hemispherical bodies 12A and 12B, and the foreign substances, such as hairs or dusts, which are stuck to the sticking/coating layer 18 are clearly cleaned to be removed after the playing of the pet is finished, the playing device for a pet may be always sanitarily managed.

As described above, in the playing device for a pet according to the present invention, because the melody and the light set by the melody generating unit 30 and the light generating unit 40 installed in the interior of the core 20 may be emitted while the playing device body 10 is rolled and rotated, the pet may be continuously interested when playing with the playing device for a pet and a luxuriousness of the product may be secured while the practicality of the product is increased through securing of the multiple functions.

Further, in the playing device for a pet according to the present invention, because the surface of the playing device body 10 is completely surrounded by the sheathing member 16, an impact generated by the pet may be absorbed so that a safety accident may be prevented.

Further, in the playing device for a pet according to the present invention, because various foreign substances, such as hairs or dusts, which are separated from a pet may be stuck due to the sticking/coating layer 18 coated on the surface of the sheathing member 16, pains of the owner for cleaning may be reduced while a convenience of cleaning may be secured in the playing process.

Further, in the playing device for a pet according to the present invention, because harmful electronic waves generated by various electronic devices may be interrupted by the tourmaline mixed in the sheathing member 16, a pet may be safely protected from electronic waves.

Further, in the playing device for a pet according to the present invention, because the core 20 may be completely separated from the playing device body 10 and the playing device body 10 may be separated into the pair of hemispherical bodies 12A and 12B, the interior and exterior of the playing device for a pet may be clearly cleaned and thus may be always sanitarily managed.

### Second Embodiment

A playing device for a pet according to a second embodiment of the present invention is the same as the first embodiment of the present invention, which has been described above, except for the structure in which the core body 22 constituting the core 20 is divided into a main body 22A and an auxiliary body 22b.

That is, the core body 22 suggested in the present embodiment is divided into the main body 22A and the auxiliary body 22B, and the main body 22A and the auxiliary body 22b are screw-coupled to each other.

Here, the melody generating unit 30, the light generating unit 40, and the control unit 50 are installed in the interior of the main body 22A.

Further, a flavoring agent, or a feed or a snack is accommodated in the auxiliary body 22B. Then, the flavoring agent may be formed of a flavoring material that emits flavors liked by a pet or a flavoring material that emits flavors capable of removing malodors of the interior of the building.

Because the flavors and odors may be emitted from the auxiliary body 22B to the outside of the playing device body due to the accommodated flavoring agent or feed, the cat may concentrate on the playing while the curiosity of the pet is maximized.

As mentioned above, in the playing device for a pet according to the present invention, the curiosity of the pet may be maximized so that an environment in which the pet may concentrate on the playing may be realized by the structure in which the flavor or feed liked by the pet may be accommodated in the auxiliary body 22B and flavors or feeds may emit smells to the outside of the playing device body 10, and the remaining operations and effects, except for those, are the same as the first embodiment of the present invention.

According to the present invention, because a preset melody and light may be emitted by the melody generating unit and the light generating unit installed in the interior of the core while the playing device body is rolled and rotated, the pet may be continuously interested while the pet plays with the playing device for a pet and the luxuriousness of the product may be realized while the practicality of the product may be increased through securing of multiple functions.

Further, because a surface of the playing device body is completely surrounded by the sheathing member, a safety accident may be prevented by absorbing an impact with a pet.

Further, because various foreign substances, such as hairs or dust, which are separated from a pet may be struck to the sticking/coating layer coated on the surface of the sheathing member, pains of the owner for cleaning may be reduced while convenience of cleaning is secured.

Further, because harmful electronic waves generated by various electronic devices may be interrupted by tourmaline mixed in the sheathing member, a pet may be protected from electronic waves.

Further, because the core may be completely separated from the playing device body and the playing device body is separated into a pair of hemispherical bodies, the inside and the outside of the playing device for a pet may be clearly cleaned so that the playing device may be always sanitarily managed.

It is apparent to those skilled in the art to which the present invention pertains that the present invention is not limited to the above-mentioned embodiments, but may be variously corrected and modified without departing from the spirit and scope of the present invention. Accordingly, the corrections or modifications are not individually understood from the technical spirit or aspects of the present invention, and the modified embodiments should belong to the scope of the present invention to which the present invention pertains.

What is claimed is:

1. A playing device for a pet, comprising:
a spherical playing device body having a hollow interior, having a plurality of emission holes and one coupling hole on a surface thereof, and configured to be rolled and rotated by a pet;
a core coupled to the interior of the playing device body through the coupling hole and having a plurality of vent holes on a surface thereof;
a melody generating unit installed in the interior of the core and configured to generate a melody when the playing device is rolled and rotated;
a light generating unit installed in the interior of the core and configured to generate light when the playing device is rolled and rotated; and
a control unit installed in the interior of the core and configured to detect an impact generated when the playing device is rotated to operate the melody generating unit and the light generating unit.

2. The playing device of claim 1, wherein the playing device body includes:
a spherical member having a pair of hemispherical bodies which are coupled to each other to form a spherical shape; and
a sheathing member coupled to the spherical member to completely surround a surface of the spherical member.

3. The playing device of claim 1, wherein the playing device body has a plurality of bosses on a surface thereof to be rolled and rotated only by an external force delivered from the pet, and the bosses have embossed shapes.

4. The playing device of claim 2, wherein the playing device body further includes:
a sticking/coating layer formed on a surface of the sheathing member such that hairs or foreign substances of the pet are stuck to the sticking/coating layer.

5. The playing device of claim 2, wherein the sheathing member is formed by mixing soft silicon and tourmaline powder.

6. The playing device of claim 1, wherein the core includes:
a core body having a hollow cylindrical shape of a specific length and having an opening on a surface thereof such that the melody generating unit, the light generating unit, and the control unit are installed in the core body; and
a cover formed to open and close the opening.

7. The playing device of claim 6, wherein the core body further includes:
a main body in which the melody generating unit, the light generating unit, and the control unit are installed; and
an auxiliary body coupled to the main body and in which feeds of the pet are accommodated.

8. The playing device of claim 1, wherein the core is formed of a transparent body such that the light generated by the light generating unit is emitted to the outside of the playing device body.

9. The playing device of claim 2, wherein the core includes:
a core body having a hollow cylindrical shape of a specific length and having an opening on a surface thereof such that the melody generating unit, the light generating unit, and the control unit are installed in the core body; and
a cover formed to open and close the opening.

10. The playing device of claim 3, wherein the core includes:
a core body having a hollow cylindrical shape of a specific length and having an opening on a surface thereof such that the melody generating unit, the light generating unit, and the control unit are installed in the core body; and
a cover formed to open and close the opening.

11. The playing device of claim 4, wherein the core includes:
a core body having a hollow cylindrical shape of a specific length and having an opening on a surface thereof such that the melody generating unit, the light generating unit, and the control unit are installed in the core body; and
a cover formed to open and close the opening.

12. The playing device of claim 5, wherein the core includes:
a core body having a hollow cylindrical shape of a specific length and having an opening on a surface thereof such that the melody generating unit, the light generating unit, and the control unit are installed in the core body; and
a cover formed to open and close the opening.
